(19) United States
(12) Patent Application Publication
(10) Pub. No.: US 2013/0080294 A1
(43) Pub. Date: Mar. 28, 2013

(54) APPARATUS AND METHOD FOR SELLING GOODS ON PERSONALIZED GIFT SITE

(71) Applicant: Sungmin HWANG, Guri-si (KR)

(72) Inventor: Sungmin HWANG, Guri-si (KR)

(21) Appl. No.: 13/495,157

(22) Filed: Jun. 13, 2012

(30) Foreign Application Priority Data
Sep. 28, 2011 (KR) 10-2011-0098578

(51) Int. Cl. G06Q 30/06

(52) U.S. Cl. 705/27.1

(57) ABSTRACT

A method for selling goods on a personalized gift site is disclosed. The method includes receiving information about at least one product selected as a gift for a service subscriber that has subscribed to an online sales service from a product list included in a personalized gift site created for the service subscriber from a terminal of a buyer by a transceiver unit, transmitting a payment request signal for the product to the terminal of the buyer through the transceiver unit by a processor unit, processing payment for the product based on payment information by the processor unit, upon receipt of the payment information from the terminal of the buyer at the transceiver unit, and generating an e-voucher including an authentication code of the selected product and transmitting the e-voucher to the terminal of the service subscriber through the transceiver unit by the processor unit.

This application claims the benefit of Korean Patent Application No. 10-2011-0098578, filed on Sep. 28, 2011, which is hereby incorporated by reference as if fully set forth herein.

### BACKGROUND OF THE INVENTION

1. Field of the Invention

The present invention relates to an apparatus and method for selling goods on a personalized gift site, and more particularly, to a method and apparatus for selling goods on a personalized gift site, which enable a buyer to access a personalized gift site created for a service subscriber that has subscribed to an online sales service, to purchase a product on the personalized gift site, and to send the purchased product in the form of an e-voucher to the service subscriber.

2. Discussion of the Related Art

Along with the development of information and communication technology, a large proportion of offline transactions now take place online. Examples of online transactions include order placement by phone, home shopping, Internet shopping, etc. Especially, the market for Internet shopping is growing rapidly all over the world.

Gift marketing is also flourishing, which means delivery of a product purchased on an Internet shopping site by a buyer to his or her acquaintance as a gift, instead of making the purchased product delivered to the buyer.

If a gift giver doesn't know what to give as a gift to an acquaintance for an occasion, the gift giver may access an Internet shopping site that the acquaintance uses, search for the acquaintance by inputting the acquaintance's name or e-mail address, and then view a gift wish list of the acquaintance.

When the acquaintance is searched for by name, a number of different persons with the same name may be listed. Then the acquaintance should be finally detected using the address or personal introduction of the acquaintance provided by the Internet shopping site, which causes user inconvenience.

When the gift giver is to purchase a gift based on the wish list, he or she should check the address of the acquaintance to which the gift is to be delivered and input the address at the moment of purchasing the gift. Therefore, the user inconvenience is increased.

Conventionally, Internet shopping sites do not provide an option for a gift recipient to select delivery of a gift to a specific location or reception of the gift in person at an offline shop. As a consequence, the gift reception is at the discretion of a gift giver.

If the gift recipient receives a gift as a gift voucher, the gift recipient may not receive the gift unless he or she visits an offline shop within the valid duration of the gift voucher, thus suffering from loss.

### SUMMARY OF THE INVENTION

Accordingly, the present invention is directed to an apparatus and method for selling goods on a personalized gift site that substantially obviate one or more problems due to limitations and disadvantages of the related art.

An object of the present invention is to provide a method and apparatus for selling goods on a personalized gift site, which enable a gift recipient to post products that the gift recipient wishes to receive on a personalized gift site and which enable a buyer to conveniently purchase a product on the personalized gift site and provide the purchased product as a gift to the gift recipient.

Another object of the present invention is to provide a method and apparatus for selling goods on a personalized gift site, which enable a gift recipient to get a gift delivered to an intended location.

Another object of the present invention is to provide a method and apparatus for selling goods on a personalized gift site, which minimizes loss to a gift recipient by depositing a predetermined amount of virtual money for the gift recipient, when the gift recipient receives a gift in the form of an e-voucher and does not use the e-voucher for a predetermined time period.

Another object of the present invention is to provide a method and apparatus for selling goods on a personalized gift site, which promote sales of goods in various marketing schemes from the perspective of a seller.

A further object of the present invention is to provide a method and apparatus for selling goods on a personalized gift site, which increase the satisfaction of both a gift giver that purchases a product and a gift recipient that receives the product, with respect to the purchase of the product.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, a method for selling goods on a personalized gift site in an apparatus for selling goods on a personalized gift site for an online sales service, which includes a processor unit, a memory unit, and a transceiver unit, includes receiving information about at least one product selected as a gift for a service subscriber that has subscribed to the online sales service from a product list included in a personalized gift site created for the service subscriber from a terminal of a buyer that has accessed the personalized gift site by the transceiver unit, transmitting a payment request signal for the product to the terminal of the buyer through the transceiver unit by the processor unit, processing payment for the product based on payment information by the processor unit, upon receipt of the payment information from the terminal of the buyer at the transceiver unit, and generating an e-voucher including an authentication code of the selected product based on destination information received in advance from a terminal of the service subscriber and transmitting the e-voucher to the terminal of the service subscriber through the transceiver unit by the processor unit.

The destination information may include at least one of a mobile phone number, an e-mail address, and a Social Networking Service (SNS) Identifier (ID) of the service subscriber.

The terminal of the buyer may access the personalized gift site by executing a menu for accessing the personalized gift site linked to an SNS of the service subscriber.

The e-voucher may include a delivery request menu for inputting delivery destination information, for delivery of the product.

The e-voucher transmission may include transmitting the e-voucher by e-mail or Short Message Service (SMS).

The method may further include generating a state information about the e-voucher and storing the state information in the memory unit by the processor unit.

The state information may include a product information, an authentication code information, an used or unused indication information for indicating whether the e-voucher is used or not, a refund information, and a valid duration information about the e-voucher.

The method may further include authenticating the e-voucher based on the state information and transmitting an authentication result to an offline shop terminal through the transceiver unit by the processor unit, upon receipt of an authentication request signal for the e-voucher, including the authentication code at the transceiver unit, receiving product handover information from the offline shop terminal by the transceiver unit, and updating the state information based on the product handover information and storing the updated state information in the memory unit by the processor unit.

The method may further include depositing virtual money corresponding to the e-voucher in an account opened when the buyer has subscribed to the online sales service and storing details of the deposit in the memory unit by the processor unit, when the processor unit determines that the valid duration of the received e-voucher has expired by comparing a current time with the valid duration of the e-voucher based on the state information, and updating the state information based on the details of the deposit and storing the updated state information in the memory unit by the processor unit.

The method may further include authenticating the e-voucher based on the state information by the processor unit, upon receipt of a refund request signal including the authentication code of the e-voucher from the terminal of the service subscriber at the transceiver unit, depositing virtual money in an account opened when the service subscriber has subscribed to the online sales service and storing details of the deposit in the memory unit, when the e-voucher turns out to be valid during the authentication, and updating the state information based on the details of the deposit and storing the updated state information in the memory unit by the processor unit.

In another aspect of the present invention, an apparatus for selling goods on a personalized gift site for an online sales service includes a processor unit, a memory unit, and a transceiver unit. The transceiver unit receives information about at least one product selected as a gift for a service subscriber that has subscribed to the online sales service from a product list included in a personalized gift site created for the service subscriber from a terminal of a buyer that has accessed the personalized gift site, and the processor unit transmits a payment request signal for the product to the terminal of the buyer through the transceiver unit, processes payment for the product based on payment information, upon receipt of the payment information from the terminal of the buyer at the transceiver unit, and generates an e-voucher including an authentication code of the selected product based on destination information received in advance from a terminal of the service subscriber and transmits the e-voucher to the terminal of the service subscriber through the transceiver unit.

The destination information may include at least one of a mobile phone number, an e-mail address, and a Social Networking Service (SNS) Identifier (ID) of the service subscriber.

The terminal of the buyer may access the personalized gift site by executing a menu for accessing the personalized gift site linked to an SNS of the service subscriber.

The e-voucher may include a delivery request menu for inputting delivery destination information, for delivery of the product.

Upon receipt of delivery destination information input in the delivery request menu from the terminal of the service subscriber, the processor unit may transmit the delivery destination information to a terminal of a retailer that sells the product through the transceiver unit.

The processor unit may generate state information about the e-voucher and stores the state information in the memory unit.

The state information may include product information, authentication code information, used or unused indication information, refund information, and valid duration information about the e-voucher.

Upon receipt of an authentication request signal for the e-voucher, including the authentication code at the transceiver unit, the processor unit may authenticate the e-voucher based on the state information about the e-voucher and transmit an authentication result to an offline shop terminal through the transceiver unit and upon receipt of product handover information from the offline shop terminal at the transceiver unit, the processor unit may update the state information based on the product handover information and store the updated state information in the memory unit.

When the processor unit may determine that the valid duration of the received e-voucher has expired by comparing a current time with the valid duration of the e-voucher based on the state information, the processor unit may deposit virtual money corresponding to the e-voucher in an account opened when the buyer has subscribed to the online sales service, store details of the deposit in the memory unit, update the state information based on the details of the deposit, and store the updated state information in the memory unit.

Upon receipt of a refund request signal including the authentication code of the e-voucher from the terminal of the service subscriber at the transceiver unit, the processor unit may authenticate the e-voucher based on the state information, deposit virtual money in an account opened when the service subscriber has subscribed to the online sales service and store details of the deposit in the memory unit, when the e-voucher turns out to be valid during the authentication, and may update the state information based on the details of the deposit and store the updated state information in the memory unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates the configuration of a system for selling goods on a personalized gift site according to the present invention;

FIG. 2 is a block diagram of a device applicable to a service server according to the present invention;

FIG. 3 is a flowchart illustrating a method for selling goods on a personalized gift site according to the present invention;

FIG. 4 illustrates an exemplary personal Web page provided by a Social Networking Service (SNS) according to the present invention;

FIG. 5 illustrates an exemplary configuration of personalized gift site created for a service subscriber according to the present invention;

FIG. 6 illustrates an exemplary e-voucher provided in the method for selling goods on a personalized gift site according to the present invention;

FIG. 7 illustrates an exemplary screen for inputting delivery destination information;

FIG. 8 is a diagram illustrating a signal flow for a procedure for exchanging a product at an offline shop in the method for selling goods on a personalized gift site according to the present invention; and

FIG. 9 is a diagram illustrating a signal flow for a refund procedure in the method for selling goods on a personalized gift site according to the present invention.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned. The term “-er(or)”, “module”, “unit” or “part” is used to signify a unit of performing at least one function or operation. The unit can be realized in hardware, software, or in combination of both.

Meanwhile, in the embodiments of the present invention, each component, function block, or device may be configured with one or more lower-layer components and its electrical, electronic and mechanical functions can be implemented with various known devices or mechanical components such as an electronic circuit, an integrated circuit, an Application Specific Integrated Circuit (ASIC), etc. Each component may be separately configured or two or more components may be incorporated into a single component.

It will be understood that each block and combinations of blocks of the attached flowchart and/or block diagram illustrations may be implemented by computer program instructions. These computer program instructions may be loaded onto a processor of a general-purpose computer, a special-purpose computer, or other programmable data processing apparatus, such that the instructions, which are executed via the processor of the computer or other programmable data processing apparatus, create means for implementing the functions specified in the flowchart and/or block diagram block or blocks. These computer program instructions may also be stored in a computer-usable or computer-readable memory that may direct a computer or other programmable data processing apparatus to function in a particular manner, such that the instructions executed in the computer-usable or computer-readable memory produce an article of manufacture including instructions that implement the function specified in the flowchart and/or block diagram block or blocks. The computer program instructions may also be loaded onto a computer or other programmable data processing apparatus to cause a series of operational steps to be performed on the computer or other programmable data processing apparatus to produce a computer implemented process such that the instructions that are executed on the computer or other programmable data processing apparatus provide steps for implementing the functions specified in the flowchart and/or block diagram block or blocks.

Each block or step may represent a module, a segment, or a portion of code, which may comprise one or more executable instructions for implementing a specified logical function or functions. It should also be noted that in some alternative embodiments, the functions noted in the blocks or steps occur out of the order. For example, two blocks or steps shown in succession may, in fact, be executed substantially concurrently or the blocks or steps may be sometimes executed in the reverse order, depending on the functionality involved.

Now a description will be given of an apparatus and method for selling goods on a personalized gift site according to the present invention

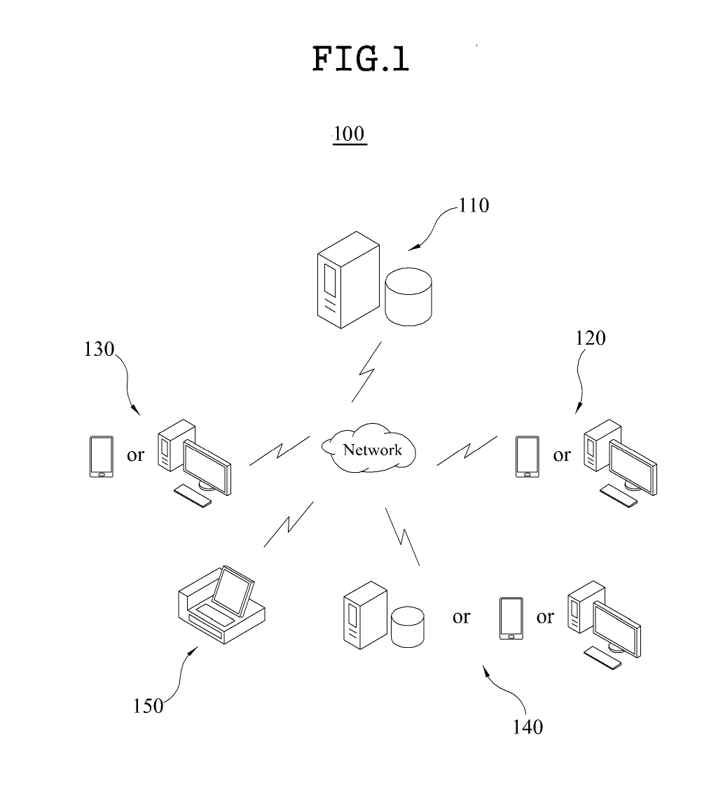

FIG. 1 illustrates the configuration of a system for selling goods on a personalized gift site according to the present invention. Referring to FIG. 1, a system 100 includes a product selling device 110 for selling goods on a personalized gift site according to the present invention, a terminal 120 of a buyer (referred to as a buyer terminal 120), a terminal 130 of a service subscriber (referred to as a service subscriber terminal 130), a terminal 140 of a retailer (referred to as a retailer terminal 140), and a terminal 150 of an offline shop (referred to as an offline shop terminal 150).

The product selling device 110 is designed to perform the method for selling goods on a personalized gift site according to the present invention, which corresponds to a server. For the convenience' sake of description, the product selling device 110 will be referred to as a service server 110.

The service server 110, the buyer terminal 120, the service subscriber terminal 130, the retailer terminal 140, and the offline shop terminal 150 are connected to one another through a network. The network may include a wired/wireless network over which signals can be transmitted and received among the service server 110, the buyer terminal 120, the service subscriber terminal 130, the retailer terminal 140, and the offline shop terminal 150.

In the present invention, the term “service subscriber” means a subscriber that has subscribed to an online sales service that is provided according to the method for selling goods on a personalized gift site and the term “buyer” means one who accesses a personalized gift site and purchases a product on the personalized gift site. The term “retailer” means one who sells products by the online sales service.

The buyer terminal 120 and the service subscriber terminal 130 include laptops and desktops as well as mobile devices such as smart pads and smart phones. As far as they are capable of providing the online sales service of the present invention through a network, any devices can be used as the buyer terminal 120 and the service subscriber terminal 130.

The retailer terminal 130 includes a server for managing services of a retailer as well as a mobile device like a smart pad and a smart phone, a laptop, and a desktop. If it enables use of the online sales service of the present invention through a network, any device can be used as the retailer terminal 130.

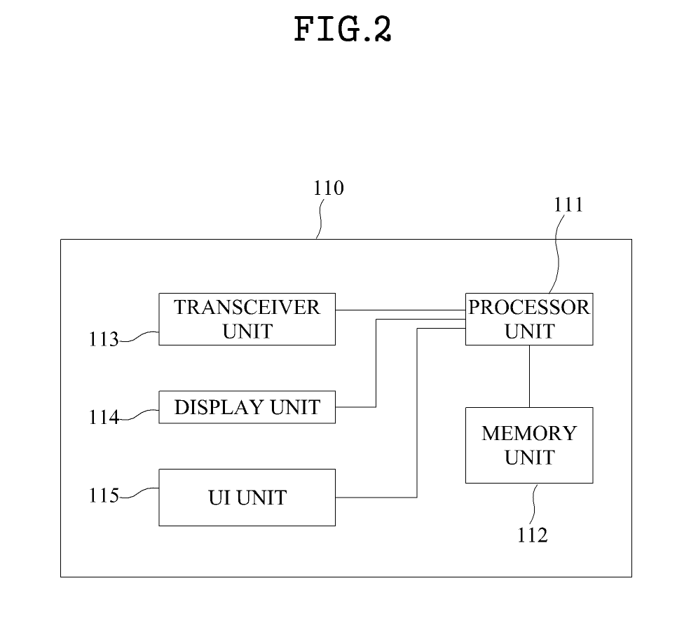

FIG. 2 is a block diagram of a device applicable to the service server according to the present invention. Referring to FIG. 2, the service server 110 includes a processor unit 111, a memory unit 112, a transceiver unit 113, a display unit 114, and a User Interface (UI) unit 115. The processor unit 111 performs the functionality of a controller for processing data and controlling processes. The memory unit 112 is electrically connected to the processor unit 111 and stores an Operating System (OS), applications, and data. The display unit 114 may display various types of information and may be configured with a known Liquid Crystal Display (LCD), Organic Light Emitting Diode (OLED), etc. The UI unit 115 may be configured by combining known UIs such as a keyboard, a keypad, a touch screen, etc. The transceiver unit 113 is electrically connected to the processor unit 111 and transmits or receives wireless or/and wired signals.

With reference to the configuration of the service server illustrated in FIG. 2, a description will be given of the method for selling goods on a personalized gift site according to the present invention.

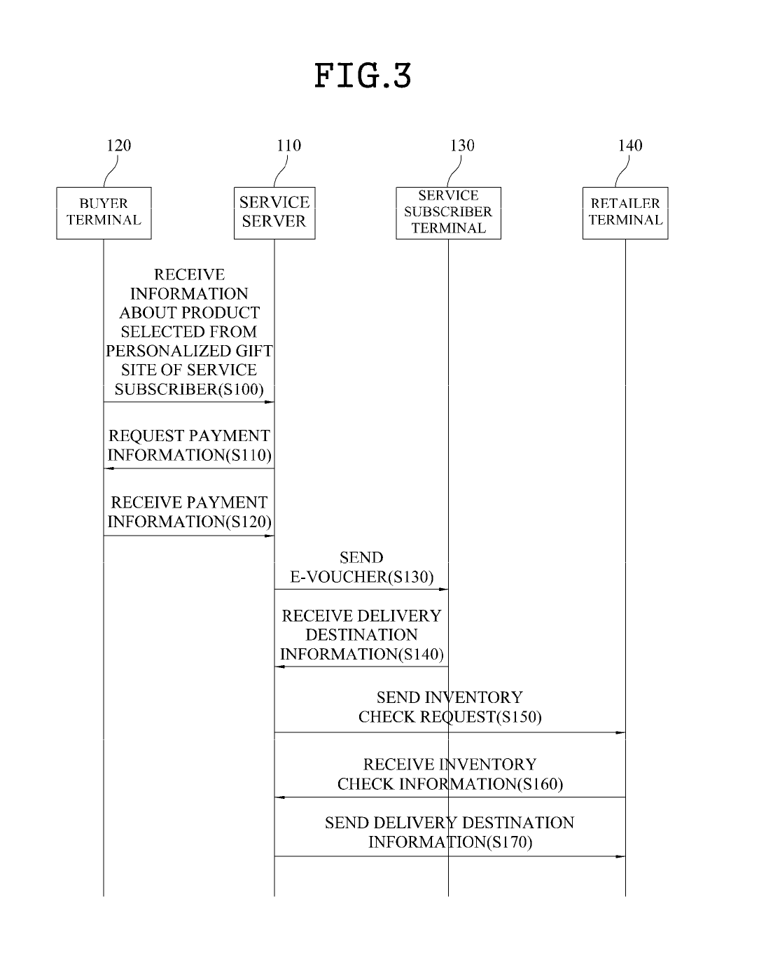

FIG. 3 is a flowchart illustrating the method for selling goods on a personalized gift site according to the present invention.

The method for selling goods on a personalized gift site according to the present invention is implemented for an online sales service. When a user subscribes to the online sales service, a personalized gift site is created for the service subscriber.

The personalized gift site may be a per-subscriber wish list provided to an individual that has subscribed to the online sales service. The subscriber may be an organization as well as an individual. For an organization (e.g. an orphanage), a personalized gift site is created for donation.

The transceiver unit 113 of the service server 110 receives information about at least one product selected as a gift for the service subscriber from a product list included in the personalized gift site from the buyer terminal 120 that has accessed the personalized gift site of the service subscriber (S100).

The buyer terminal 120 may access the personalized gift site by executing an access menu for the personalized gift site which is linked to a Social Networking Service (SNS) of the service subscriber.

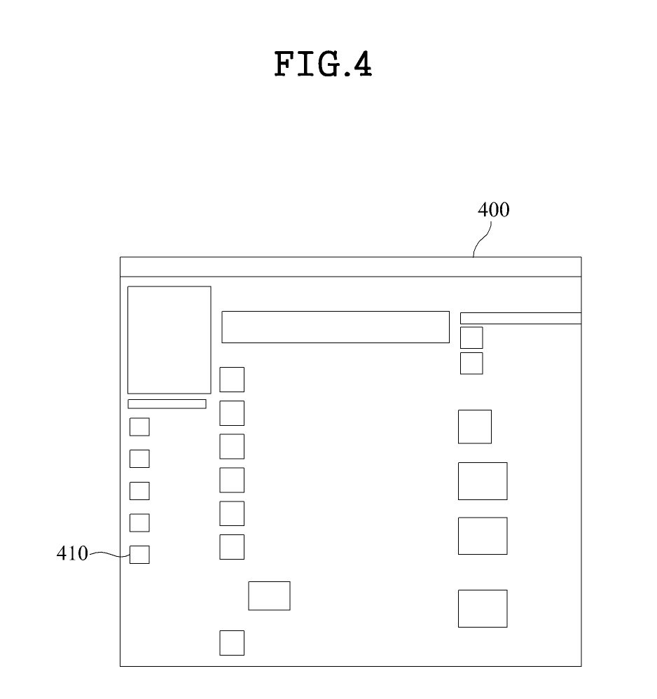

FIG. 4 illustrates an exemplary personal Web page provided by an SNS according to the present invention.

Referring to FIG. 4, an SNS subscriber is given a personal SNS Web page on which the SNS subscriber can communicate with other SNS subscribers. The SNS subscriber may hear from other SNS subscribers set as friends or learn to know what is going on with them on the Web page. If the service subscriber that subscribed to the online sales service of the present invention also subscribes to an SNS, a menu 410 that links a personal SNS Web page created for the service subscriber to the personalized gift site provided by the online sales service may be added to the personal SNS Web page. When the buyer accesses the personal SNS Web page of the service subscriber using the buyer terminal 120 and executes the menu 410, the personalized gift site of the service subscriber linked to the SNS Web page appears.

However, access to the personalized gift site is not restricted to execution of the access menu of the SNS-linked gift site. If the personalized gift site is linked to a home page of a person or an organization, the personalized gift site may be accessed through the home page. In addition, if the personalized gift site is linked to a home page of the online sales service of the present invention, the personalized gift site may be accessed through the home page.

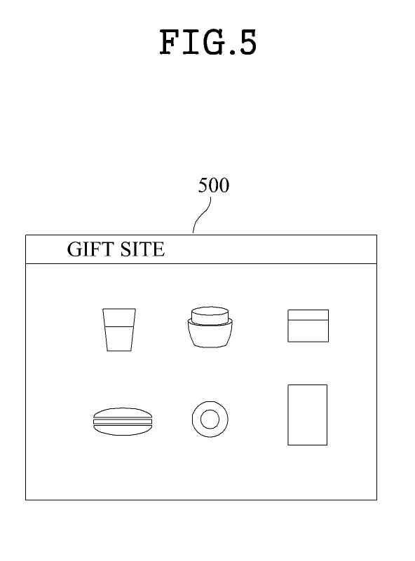

FIG. 5 illustrates an exemplary configuration of a personalized gift site created for a service subscriber according to the present invention.

Referring to FIG. 5, a personalized gift site 500 includes a product list in which products that the service subscriber wishes to buy or receive are arranged. When an image of a product is clicked, a page of the product may appear, including a description, enlarged image, and price of the product, etc.

The product list displayed on the personalized gift site 500 may be created with information about products selected from a list of products sold on a main site that provides the online sales service. The service server 110 provides a function of allowing the service subscriber to select a desired gift on the main site and upload the selected gift to the personalized gift site.

That is, if the service subscriber accesses the main site, selects an intended product using the service subscriber terminal 130, and executes a menu for adding the selected product to the personalized gift site 500, the product is uploaded and displayed on the personalized gift site 500.

The service subscriber may access the main site and add an intended product to the personalized gift site. In addition, the service subscriber may access the personalized gift site and delete an unintended product among displayed products. In this manner, the service subscriber may manage the personalized gift site freely.

The service server 110 may also provide a menu for setting a background image and a menu for setting background music, for the personalized gift site 500. In addition, the service server 110 may provide a menu for allowing the service subscriber to post a photo or a comment to the personalized gift site 500. Accordingly, the personalized gift site 500 may serve as a personal blog. As the service subscriber can freely post an intended product on the personalized gift site 500, visitors to the personalized gift site 500 may be attracted to buy a desired product and give it as a gift to the service subscriber.

A personalized gift site may also be created for an organization as well as for an individual. For an organization (e.g. an orphanage), products needed for the organization may be displayed on the personalized gift site, for donation.

To allow a buyer to search for the personalized gift site of a service subscriber to which the buyer wants to give a gift, when the service subscriber subscribes to the online sales service of the present invention, the service subscriber may be prompted to input personal information such as a mobile phone number, an e-mail address, a name, etc. Thus the buyer may search for the service subscriber based on the personal information and access the personalized gift site of the service subscriber.

Referring to FIG. 3 again, when the transceiver unit 113 of the service server 110 receives information about at least one product selected as a gift for the service subscriber from the product list included in the personalized gift site from the buyer terminal 120 that has accessed the personalized gift site of the service subscriber (S100), the processor unit 111 of the service server 110 generates a payment information request signal and transmits the payment information request signal to the buyer terminal 120 through the transceiver unit 113 (S110).

Upon receipt of payment information at the transceiver unit 113 from the buyer terminal 120 (S120), the processor unit 111 processes payment for the product based on the payment information.

That is, when the gift buyer accesses the personalized gift site of the service provider, selects at least one of products displayed on the personalized gift site, and decides to purchase the selected product, information about the selected product is transmitted to the service server 110 and the service server 110 processes the payment for the product.

Subsequently, the processor unit 111 generates an e-voucher including an authentication code of the selected product using destination information received in advance from the service subscriber terminal 120 and transmits the e-voucher to the service subscriber terminal 120 through the transceiver unit 113 (S130). To manage the transmitted e-voucher, the processor unit 111 generates state information about the e-voucher and stores it in the memory unit 112 during generating the e-voucher. The state information product information, authentication code information, used or unused indication information, refund information, and valid duration information regarding the e-voucher. The e-voucher is an electronic voucher that can be transmitted by e-mail, Short Message Service (SMS), or an application installed in a smart phone.

The destination information includes at least one of the mobile phone number, e-mail address, and SNS ID of the service subscriber, to which the e-voucher can be transmitted. Accordingly, the e-voucher may be transmitted by e-mail, an SMS message, or an SNS message.

Since the service subscriber input information about a destination at which an e-voucher is supposed to be transmitted during subscription to the online sales service, once the buyer selects and purchases a product on the personalized gift site, an e-voucher of the product can be transmitted conveniently to the destination without the need for further inputting information about a destination at which the service subscriber will receive the product.

If an application for providing the service is installed in the service subscriber terminal 130, the e-voucher may be provided to the service subscriber by the application.

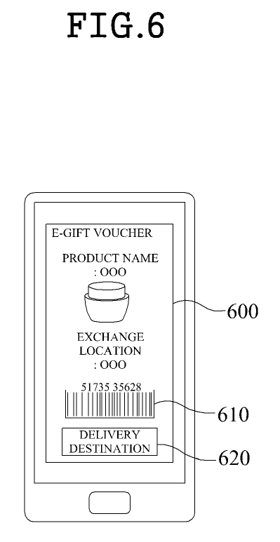

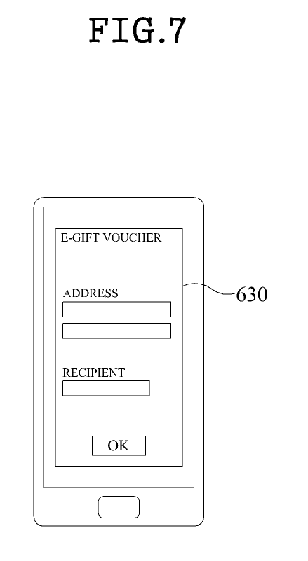

FIG. 6 illustrates an exemplary e-voucher provided in the method for selling goods on a personalized gift site according to the present invention, and FIG. 7 illustrates an exemplary screen for inputting delivery destination information.

Referring to FIG. 6, the service subscriber may receive an e-voucher 600 through the service subscriber terminal 130 being a mobile device such as a smart phone.

The e-gift voucher 600 may include information about a selected product, an offline shop that sells the product, a buyer that has purchased the product as a gift, and/or a message from the buyer. The message may include text, an image like a photo, or a video.

Accordingly, when receiving the e-voucher 600, the service subscriber may visit in person the offline shop that sells the product and receive the product, based on the information included in the e-voucher 600.

When the service subscriber visits the offline shop and wants to receive or exchange the product, the offline shop may scan a barcode 610 of the e-voucher 600 and thus display the product information, etc. on a display screen in real time.

A delivery destination information input menu 620 may be included in the e-voucher 600, such that if the service subscriber wants to get the product as a gift delivered to a specific location after receiving the e-voucher 600, the service subscriber may input the delivery destination of the product directly.

When the service subscriber selects the delivery destination input menu 620 in the e-voucher 600, a delivery destination input screen 630 is displayed as illustrated in FIG. 7.

If the service subscriber executes the delivery destination input menu 620 and inputs delivery destination information in the delivery destination input screen 630 after receiving the e-voucher 600, the service subscriber terminal 130 transmits the delivery destination information to the service server 110, particularly to the transceiver 113 (S140). The delivery destination information includes an authentication code that identifies the e-voucher 600.

Upon receipt of the delivery destination information, the processor unit 111 of the service server 110 authenticates whether the e-voucher 600 is valid based on the received authentication code and the state information. That is, the processor unit 111 determines whether the e-voucher 600 can be used by checking whether there is an e-voucher corresponding to the authentication code of the e-voucher 600, whether the e-voucher 600 has been used, whether the e-voucher 600 has been refunded, whether the valid duration of the e-voucher 600 has elapsed, etc.

If the processor unit 111 determines that the e-voucher 600 can be used, the processor unit 111 transmits an inventory check request signal to the retailer terminal 140 through the transceiver unit 113 in order to determine whether the product of the e-voucher 600 is in stock (S150)

Upon receipt of inventory check information indicating whether the product is in stock at the transceiver unit 111 from the retailer terminal 140 (S160), the processor unit 111 determines whether the product is in stock based on the inventory check information. If determining that the product is in stock, the processor unit 111 transmits the delivery destination information to the retailer terminal 140 through the transceiver unit 113 (S170). On the other hand, if determining that the product is not in stock, the processor unit 111 may transmit to the service subscriber terminal 130 a notification message indicating that the product can be refunded or exchanged for another product due to no stock of the product.

The processor unit 111 transmits the delivery destination information to the retailer terminal 150 of the retailer selling the product through the transceiver unit 113. The retailer is an entity that registers its products to the main site of the online sales service and sells the products in the method for selling goods on a personalized gift site according to the present invention. That is, products that are sold by a plurality of retailers may be registered on the main site.

To manage the transmitted e-voucher, the processor unit 111 generates state information about the e-voucher and stores it in the memory unit 112 during generating the e-voucher.

The state information about the e-voucher includes product information, authentication code information, used or unused indication information indicating whether the e-voucher has been used, refund information, and valid duration information regarding the e-voucher.

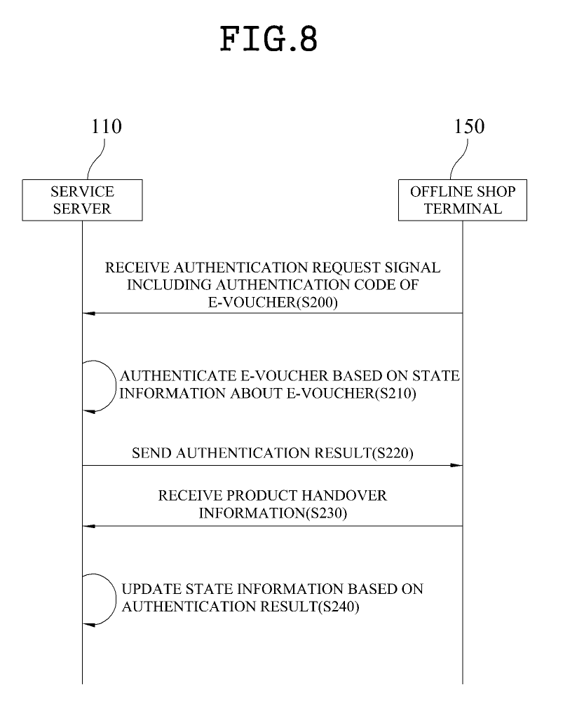

FIG. 8 is a diagram illustrating a signal flow for a procedure for exchanging a product at an offline shop in the method for selling goods on a personalized gift site according to the present invention.

Referring to FIG. 8, when the offline shop terminal 150 such as a Point Of Sales (POS) machine scans the authentication code of the e-voucher through a barcode reader, the offline shop terminal 150 senses the authentication code and transmits an authentication request signal for the e-voucher, including the authentication code, to the service server 110.

Upon receipt of the authentication request signal at the transceiver unit 113 (S200), the processor unit 111 performs an authentication procedure based on the state information about the e-voucher (S210). That is, the processor unit 111 determines based on the state information about the e-voucher whether the e-voucher corresponding to the authentication code has already been used, whether the e-voucher has already been refunded, and whether its valid duration has elapsed, during the authentication procedure.

The processor unit 111 transmits an authentication result to the offline shop terminal 150 through the transceiver unit 113 (S220). If the authentication result indicates that the e-voucher is valid and thus the product corresponding to the e-voucher is handed over to the service subscriber, the offline store terminal 140 transmits product handover information indicating that the product corresponding to the e-voucher has been handed over to the service server 110.

Upon receipt of the product handover information at the transceiver unit 113 (S230), the processor unit 111 updates the state information about the e-voucher based on the product handover information and stores the updated state information in the memory unit 112 (S240). That is, since the e-voucher has been redeemed for the product, the processor unit 111 updates the used or unused indication information in the state information and stores the updated state information in the memory unit 112.

The valid duration of the e-voucher is preset. If the e-voucher has not been used within the valid duration, virtual money is deposited for the buyer, to thereby prevent loss caused by non-use of the e-voucher in the following procedure.

The processor unit 111 compares a current time with the valid duration of the received e-voucher indicated by the state information about the e-voucher. If the e-voucher has been expired, the processor unit 111 may deposit virtual money corresponding to the e-voucher in an account that was opened when the buyer subscribed to the online sales service and may store details of the deposit in the memory unit 112. In view of the refund of the expired e-voucher, the processor unit 111 updates the refund information in the state information and stores the updated state information in the memory unit 112.

While it has been described in the procedure that the virtual money is deposited for the buyer, the virtual money can be deposited for the service subscriber when the e-voucher has been expired.

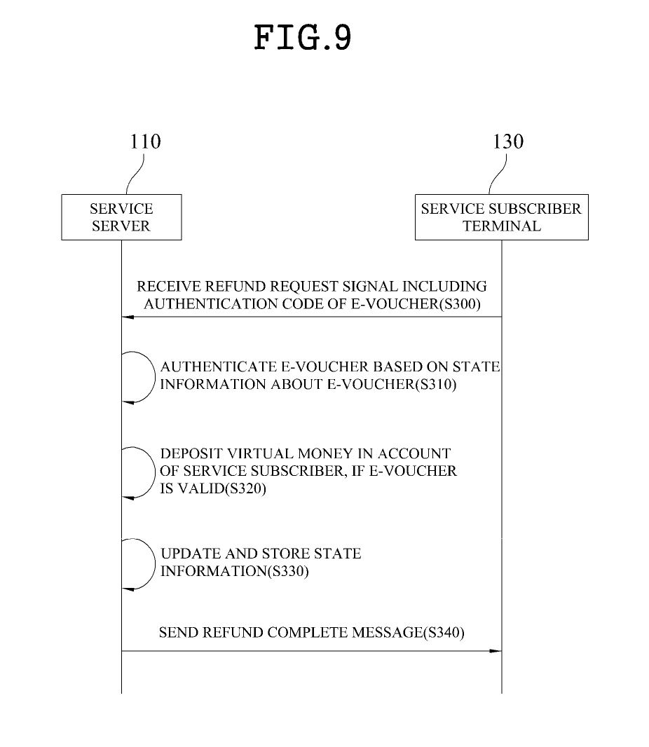

FIG. 9 is a diagram illustrating a signal flow for a refund procedure in the method for selling goods on a personalized gift site according to the present invention.

Upon receipt of a refund request signal including the authentication code of the e-voucher at the transceiver unit 113 from the service subscriber terminal 130 (S300), the processor unit 111 authenticates the e-voucher based on the state information about the e-voucher (S310). That is, the processor unit 111 checks based on the state information whether the e-voucher corresponding to the authentication code has already been expired, whether the e-voucher has already been refunded, etc. If the e-voucher turns out to be valid during the authentication, the processor unit 111 deposits virtual money in an account of the service subscriber and stores details of the deposit in the memory unit 112 (S320). Then the processor unit 111 updates the state information and stores the updated state information in the memory unit 112 (S330). In addition, upon completion of the refund procedure, the processor unit 111 transmits a refund complete message indicating successful refunding to the service subscriber terminal 130 through the transceiver unit 113 (S340).

While it has been described in the procedure of FIG. 9 that the service subscriber refunds an e-voucher, the buyer may request refund of the e-voucher in the same procedure before the e-voucher is used.

As is apparent from the above description of the apparatus and method for selling goods on a personalized gift site according to the present invention, a buyer can conveniently purchase an intended product on a personalized gift site in which a gift recipient has posted wished products and can give the purchased product to the gift recipient.

The gift recipient can request delivery of the product to an intended location.

Since the gift recipient receives a wished product as a gift, the satisfaction of the product is increased, thus reducing returns.

If the gift recipient receives a product in the form of an e-voucher and does not use the e-voucher during a predetermined time period, virtual money is deposited for the gift recipient, thereby minimizing unused e-voucher-caused loss.

From the perspective of a product seller, products can be marketed in various manners.

Those skilled in the art will appreciate that the present invention may be carried out in other specific ways than those set forth herein without departing from the spirit and essential characteristics of the present invention. For example, those skilled in the art can change the material, size, etc. of each component according to an application field and implement the disclosed embodiments of the present invention by combination or replacement in a manner that is not clearly disclosed in the embodiments of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method for selling goods on a personalized gift site in an apparatus for selling goods on a personalized gift site for an online sales service, which includes a processor unit, a memory unit, and a transceiver unit, the method comprising:
receiving information about at least one product selected as a gift for a service subscriber that has subscribed to the online sales service from a product list included in a personalized gift site created for the service subscriber from a terminal of a buyer that has accessed the personalized gift site by the transceiver unit;
transmitting a payment request signal for the product to the terminal of the buyer through the transceiver unit by the processor unit;
processing payment for the product based on payment information by the processor unit, upon receipt of the payment information from the terminal of the buyer at the transceiver unit; and
generating an e-voucher including an authentication code of the selected product based on destination information received in advance from a terminal of the service subscriber and transmitting the e-voucher to the terminal of the service subscriber through the transceiver unit by the processor unit.

2. The method according to claim 1, wherein the destination information includes at least one of a mobile phone number, an e-mail address, and a Social Networking Service (SNS) Identifier (ID) of the service subscriber.

3. The method according to claim 1, wherein the terminal of the buyer accesses the personalized gift site by executing a menu for accessing the personalized gift site linked to an SNS of the service subscriber.

4. The method according to claim 1, wherein the e-voucher includes a delivery request menu for inputting delivery destination information, for delivery of the product.

5. The method according to claim 1, wherein the e-voucher transmission comprises transmitting the e-voucher by e-mail or Short Message Service (SMS).

6. The method according to claim 1, further comprising generating a state information about the e-voucher and storing the state information in the memory unit by the processor unit.

7. The method according to claim 6, wherein the state information includes a product information, an authentication code information, an used or unused indication information for indicating whether the e-voucher is used or not, a refund information, and a valid duration information about the e-voucher.

8. The method according to claim 6, further comprising:
authenticating the e-voucher based on the state information and transmitting an authentication result to an offline shop terminal through the transceiver unit by the processor unit, upon receipt of an authentication request signal for the e-voucher, including the authentication code at the transceiver unit;
receiving product handover information from the offline shop terminal by the transceiver unit; and
updating the state information based on the product handover information and storing the updated state information in the memory unit by the processor unit.

9. The method according to claim 6, further comprising:
depositing virtual money corresponding to the e-voucher in an account opened when the buyer has subscribed to the online sales service and storing details of the deposit in the memory unit by the processor unit, when the processor unit determines that the valid duration of the received e-voucher has expired by comparing a current time with the valid duration of the e-voucher based on the state information; and
updating the state information based on the details of the deposit and storing the updated state information in the memory unit by the processor unit.

10. The method according to claim 6, further comprising:
authenticating the e-voucher based on the state information by the processor unit, upon receipt of a refund request signal including the authentication code of the e-voucher from the terminal of the service subscriber at the transceiver unit;
depositing virtual money in an account opened when the service subscriber has subscribed to the online sales service and storing details of the deposit in the memory unit, when the e-voucher turns out to be valid during the authentication; and
updating the state information based on the details of the deposit and storing the updated state information in the memory unit by the processor unit.

11. An apparatus for selling goods on a personalized gift site for an online sales service, comprising:
a processor unit;
a memory unit; and
a transceiver unit,
wherein the transceiver unit receives information about at least one product selected as a gift for a service subscriber that has subscribed to the online sales service from a product list included in a personalized gift site created for the service subscriber from a terminal of a buyer that has accessed the personalized gift site, and the processor unit transmits a payment request signal for the product to the terminal of the buyer through the transceiver unit, processes payment for the product based on payment information, upon receipt of the payment information from the terminal of the buyer at the transceiver unit, and generates an e-voucher including an authentication code of the selected product based on destination information received in advance from a terminal of the service subscriber and transmits the e-voucher to the terminal of the service subscriber through the transceiver unit.

12. The apparatus according to claim 11, wherein the destination information includes at least one of a mobile phone number, an e-mail address, and a Social Networking Service (SNS) Identifier (ID) of the service subscriber.

13. The apparatus according to claim 11, wherein the terminal of the buyer accesses the personalized gift site by executing a menu for accessing the personalized gift site linked to an SNS of the service subscriber.

14. The apparatus according to claim 11, wherein the e-voucher includes a delivery request menu for inputting delivery destination information, for delivery of the product.

15. The apparatus according to claim 14, wherein upon receipt of delivery destination information input in the delivery request menu from the terminal of the service subscriber, the processor unit transmits the delivery destination information to a terminal of a retailer that sells the product through the transceiver unit.

16. The apparatus according to claim 11, wherein the processor unit generates state information about the e-voucher and stores the state information in the memory unit.

17. The apparatus according to claim 16, wherein the state information includes product information, authentication code information, used or unused indication information, refund information, and valid duration information about the e-voucher.

18. The apparatus according to claim 16, wherein upon receipt of an authentication request signal for the e-voucher, including the authentication code at the transceiver unit, the processor unit authenticates the e-voucher based on the state information about the e-voucher and transmits an authentication result to an offline shop terminal through the transceiver unit and upon receipt of product handover information from the offline shop terminal at the transceiver unit, the processor unit updates the state information based on the product handover information and stores the updated state information in the memory unit.

19. The apparatus according to claim 16, wherein when the processor unit determines that the valid duration of the received e-voucher has expired by comparing a current time with the valid duration of the e-voucher based on the state information, the processor unit deposits virtual money corresponding to the e-voucher in an account opened when the buyer has subscribed to the online sales service, stores details of the deposit in the memory unit, updates the state information based on the details of the deposit, and stores the updated state information in the memory unit.

20. The apparatus according to claim 16, wherein upon receipt of a refund request signal including the authentication code of the e-voucher from the terminal of the service subscriber at the transceiver unit, the processor unit authenticates the e-voucher based on the state information, deposits virtual money in an account opened when the service subscriber has subscribed to the online sales service and stores details of the deposit in the memory unit, when the e-voucher turns out to be valid during the authentication, and updates the state information based on the details of the deposit and stores the updated state information in the memory unit.
